(19) United States
(12) Patent Application Publication
(10) Pub. No.: US 2021/0065659 A1
(43) Pub. Date: Mar. 4, 2021

(54) IMAGE PROCESSING APPARATUS, IMAGE PROCESSING METHOD, PROGRAM, AND PROJECTION SYSTEM

(71) Applicant: SONY CORPORATION, TOKYO (JP)

(72) Inventors: NAOMASA TAKAHASHI, CHIBA (JP); TATSUSHI NASHIDA, KANAGAWA (JP); YOSHIYUKI TAKAO, TOKYO (JP)

(21) Appl. No.: 16/961,104

(22) PCT Filed: Jan. 11, 2019
(86) PCT No.: PCT/JP2019/000627

§ 371 Date: Jul. 9, 2020

(30) Foreign Application Priority Data
Jan. 25, 2018 (JP) 2018-010190

(51) Int. Cl. G09G 5/377; G03B 21/58; H04N 9/31; H04N 5/74

(52) U.S. Cl. CPC G09G 5/377; G03B 21/58; H04N 5/74; H04N 9/3185; H04N 9/3147

(57) ABSTRACT

The present technology relates to an image processing apparatus, an image processing method, a program, and a projection system that can prevent a sense of realism and immersion from being impaired even in a case where a planar image generated on the assumption that the planar image is to be displayed on a flat surface is displayed on a curved display surface. An image processing apparatus according to an embodiment of the present technology causes a planar image and an effect image to be displayed on a curved display surface such that an image representing a predetermined space is displayed as the effect image around the planar image, the planar image having been generated on the assumption that the planar image is to be displayed on a flat surface. The present technology can be applied to a computer that causes a plurality of projectors to project a video.

### TECHNICAL FIELD

The present technology relates to an image processing apparatus, an image processing method, a program, and a projection system, and particularly, to an image processing apparatus, an image processing method, a program, and a projection system that can prevent a sense of realism and immersion from being impaired even in a case where a planar image generated on the assumption that the planar image is to be displayed on a flat surface is displayed on a curved display surface.

### BACKGROUND ART

There is a projection system that can give the user a sense of realism and immersion by projecting an image on a dome-shaped screen.

As a method of photographing an image to be projected in such a projection system, a method of photographing using a plurality of cameras including f·tanθ lenses or using a plurality of cameras including fθ lenses called fisheyes is common. Performing image processing such as stitching and blending on the images photographed by the plurality of cameras generates a spherical image in a format using the equirectangular projection or in a format called a dome master. The resulting spherical image is used for projection.

### CITATION LIST

### Patent Literature

### [PTL 1]

Japanese Patent Laid-open No. 2012-44407

### SUMMARY

### Technical Problems

The number of pieces of spherical image content is far smaller than the number of pieces of content such as movies and television programs that are assumed to be viewed using a flat display device.

Therefore, such a situation that projection systems with a dome-shaped screen utilize content that is assumed to be viewed using a flat display device is expected to continue.

The present technology has been made in view of the situation above and can prevent a sense of realism and immersion from being impaired even in a case where a planar image generated on the assumption that the planar image is to be displayed on a flat surface is displayed on a curved display surface.

### Solution to Problems

An image processing apparatus according to one aspect of the present technology includes a display control section configured to cause a planar image and an effect image to be displayed on a curved display surface such that an image representing a predetermined space is displayed as the effect image around the planar image, the planar image having been generated on the assumption that the planar image is to be displayed on a flat surface.

A projection system according to another aspect of the present technology includes a screen having a curved projection surface, a projector configured to project an image on the screen, and an image processing apparatus including a projection control section configured to cause the projector to project a planar image and an effect image on the projection surface such that an image representing a predetermined space is displayed as the effect image around the planar image, the planar image having been generated on the assumption that the planar image is to be displayed on a flat surface.

In one aspect of the present technology, a planar image and an effect image are displayed on the curved display surface such that an image representing a predetermined space is displayed as the effect image around the planar image. The planar image has been generated on the assumption that the planar image is to be displayed on a flat surface.

In another aspect of the present technology, a planar image and an effect image are projected on the screen having the curved projection surface from the projector such that an image representing a predetermined space is displayed as the effect image around the planar image. The planar image has been generated on the assumption that the planar image is to be displayed on a flat surface.

### ADVANTAGEOUS EFFECTS OF INVENTION

According to the present technology, a sense of realism and immersion can be prevented from being impaired even in a case where a planar image generated on the assumption that the planar image is to be displayed on a flat surface is displayed on a curved display surface.

It is noted that the effects described herein are not necessarily limited, and any of the effects described in the present disclosure may be provided.

### [BRIEF DESCRIPTION OF DRAWINGS]

FIG. 1 is a diagram illustrating an example of a configuration of a multi-projection system.

FIG. 2 is a diagram illustrating the positions of projectors from above.

FIG. 3 is a diagram illustrating an example of a viewpoint position.

FIG. 4 is a diagram illustrating an example of an image of content.

FIG. 5 is a diagram illustrating an example of superimposition of an effect image.

FIG. 6 is a diagram illustrating a projection state.

FIG. 7 is a diagram illustrating an example of a 360-degree image.

FIG. 8 is a diagram illustrating examples of the effect image.

FIG. 9 is a diagram illustrating other examples of the effect image.

FIG. 10 is a diagram illustrating an effect obtained by projecting the effect image.

FIG. 11 is a block diagram illustrating an example of a hardware configuration of an image processing apparatus.

FIG. 12 is a block diagram illustrating an example of a functional configuration of the image processing apparatus.

FIG. 13 is a flowchart for describing a content reproduction process of the image processing apparatus.

FIG. 14 is a block diagram illustrating an example of a hardware configuration of a content generation apparatus.

FIG. 15 is a block diagram illustrating an example of a functional configuration of the content generation apparatus.

FIG. 16 is a diagram illustrating an example of content including both a planar image and a 360-degree image.

FIG. 17 is a diagram illustrating an example of a timeline of content.

FIG. 18 is a diagram illustrating an example of arrangement of virtual screens.

FIG. 19 is a diagram illustrating another example of the configuration of the multi-projection system.

### DESCRIPTION OF EMBODIMENT

A mode for carrying out the present technology will be described below. The description will be given in the following order.

1. Configuration of Multi-Projection System

2. Regarding Image of Content

3. Configuration of Image Processing Apparatus

4. Operation of Image Processing Apparatus

5. Regarding Generation of Content

6. Modifications

### <Configuration of Multi-Projection System>

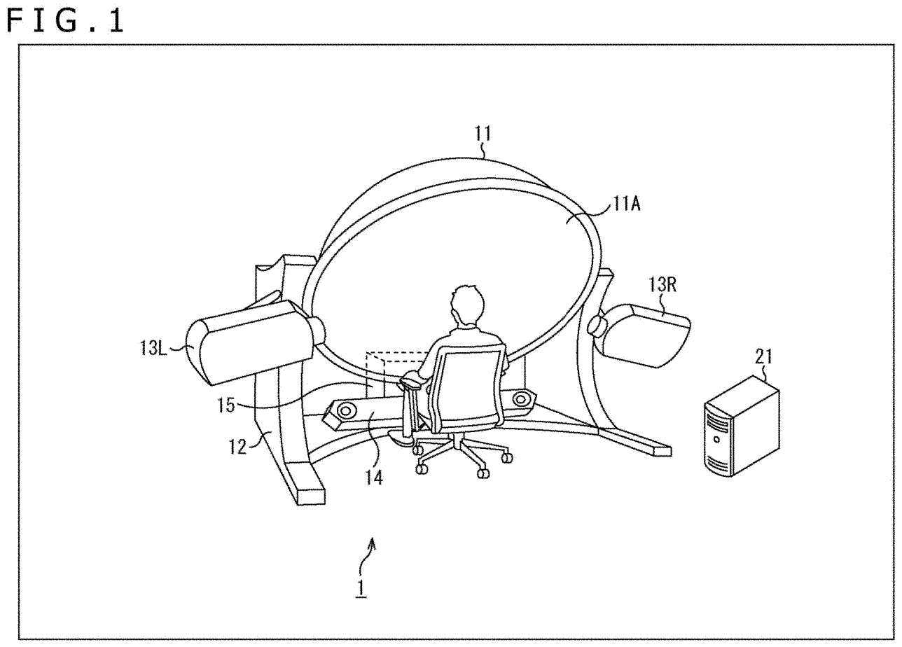

FIG. 1 is a diagram illustrating an example of a configuration of a multi-projection system according to an embodiment of the present technology.

A multi-projection system 1 of FIG. 1 includes a dome screen 11, which is mounted on a mounting base 12. The dome screen 11 has a dome-shaped (hemispherical) projection surface 11A having a diameter of approximately 2 meters. The dome screen 11 is mounted at a height of substantially 1 meter with its opening directed obliquely downward.

As illustrated in FIG. 1, a chair is arranged in front of the dome screen 11. The user views content projected on the projection surface 11A while sitting in the chair.

Further, the multi-projection system 1 also includes projectors 13L and 13R, a surround speaker 14, a woofer 15, and an image processing apparatus 21. The projectors 13L and 13R, the surround speaker 14, and the woofer 15 are connected to the image processing apparatus 21 through wired or wireless communication.

The projectors 13L and 13R are attached to the left and right of the dome screen 11, respectively, with their projection sections facing the dome screen 11.

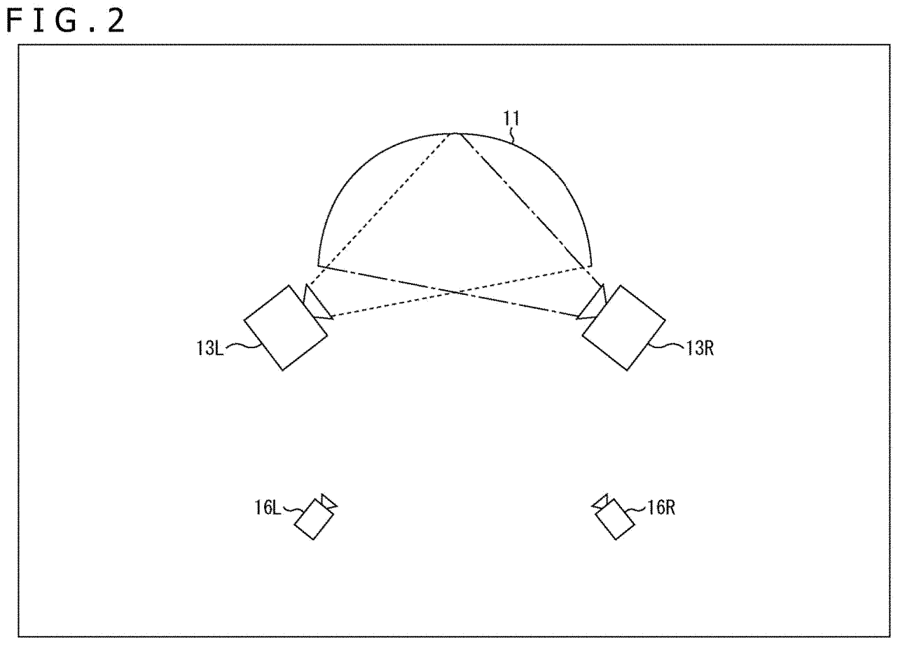

FIG. 2 is a diagram illustrating the positions of the projectors 13L and 13R from above.

As illustrated in FIG. 2, the projector 13L is attached to a position where the projector 13L can project an image on a right-half area of the dome screen 11, while the projector 13R is attached to a position where the projector 13R can project an image on a left-half area of the dome screen 11. In FIG. 2, a range indicated by a broken line represents a projection range of the projector 13L, while a range indicated by a dashed-dotted line represents a projection range of the projector 13R.

The projectors 13L and 13R project respective projection images allocated thereto to display an image of content on the entire projection surface 11A and present the image to the user. The projection image of each projector is generated on the basis of the image of the content such that the user can view one image without distortion from the viewpoint of the user.

The surround speaker 14 and the woofer 15 provided below the dome screen 11 output audio of the content reproduced by the image processing apparatus 21.

The multi-projection system 1 also includes cameras 16L and 16R (FIG. 2). For example, the cameras 16L and 16R are provided at positions where their photographing ranges include the user viewing content. The cameras 16L and 16R transmit photographed images obtained by photographing the state of the user viewing the content to the image processing apparatus 21 through wired or wireless communication.

The image processing apparatus 21 reproduces content and generates a projection image for each projector on the basis of each frame that constitutes a moving image of the content. The image processing apparatus 21 outputs the projection images to the respective projectors 13L and 13R, causing the projectors 13L and 13R to project the projection images onto the projection surface 11A.

Further, the image processing apparatus 21 outputs audio data obtained by reproducing the content to the surround speaker 14 and the woofer 15, causing the surround speaker 14 and the woofer 15 to output the audio of the content.

The image processing apparatus 21 is, for example, a PC. The image processing apparatus 21 may include a plurality of PCs instead of one PC. Further, the image processing apparatus 21 may be provided in a room different from a room in which the dome screen 11 is provided, instead of being provided in the vicinity of the dome screen 11 as illustrated in FIG. 1.

It is noted that although two projectors are provided in the example of FIG. 1, one projector may be provided or three or more projectors may be provided. Any number of projectors is provided in the multi-projection system 1.

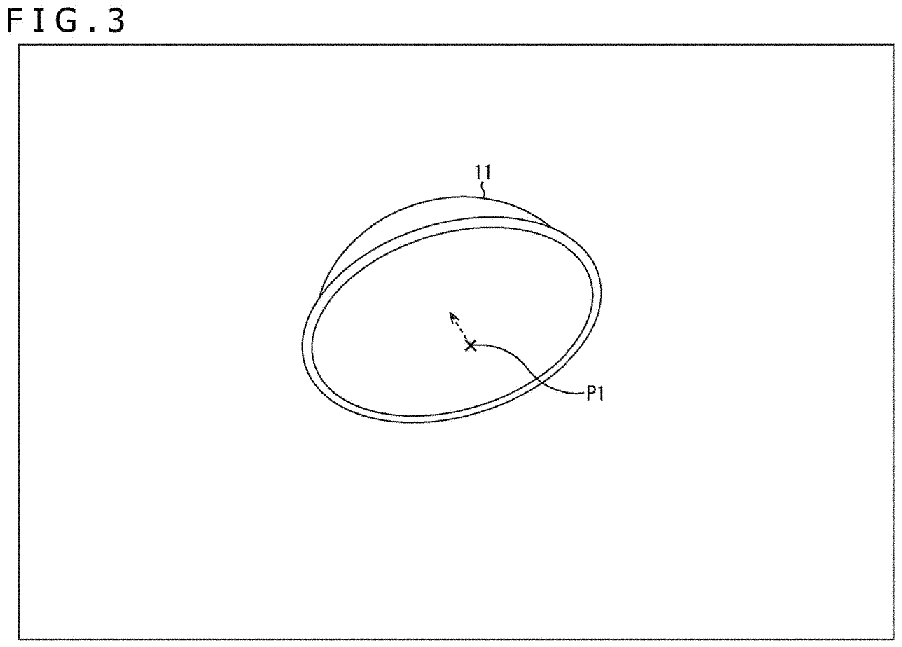

FIG. 3 is a diagram illustrating an example of a viewpoint position.

With a position P1 as the viewpoint position, the user sitting in the chair, which is placed in front of the dome screen 11, views an image projected on the projection surface 11A by looking up slightly as indicated by a broken arrow. The position P1 is located in the vicinity of the center of the sphere in a case where the projection surface 11A is the sphere surface. The position of a backmost portion of the projection surface 11A indicated by the broken arrow of FIG. 3 is the center position of the projection surface 11A.

Since the user views the projection image by looking up with the position P1 as the viewpoint position, the user's field of view is mostly covered by the image projected on the projection surface 11A. With almost the entire field of view covered by the image, the user can get an impression as if the user were surrounded by the image and can obtain a sense of realism and immersion in the content.

For example, content of a moving image such as a movie, a television program, or a game is provided. Content of a still image such as a photograph of a landscape may be provided.

### <Regarding Image of Content>

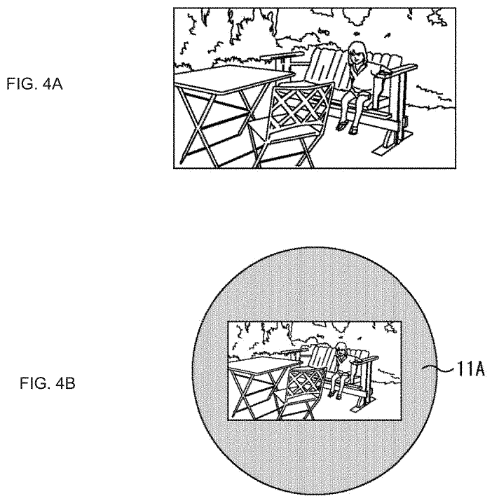

FIG. 4 is a diagram illustrating an example of an image of content.

The horizontally long rectangular image illustrated in A of FIG. 4 is an image of one frame obtained by reproducing content of a movie. During the reproduction of the content of the movie, an image of each frame whose ratio of the horizontal length to the vertical length is, for example, 16:9 is presented to the user.

The image obtained by reproducing the content is a planar image generated on the assumption that the image is to be displayed on a flat display or projected on a flat screen.

It is noted that in a case where the planar image is projected as it is on the projection surface 11A, the planar image is projected with distortion. In the image processing apparatus 21, a geometric transformation of the planar image is performed on the basis of geometric information. In the geometric information, each pixel of the planar image obtained by reproducing the content is associated with each position on the projection surface 11A. Accordingly, an image is projected without distortion in a case where the position P1 is the viewpoint position.

Thus, a space is virtually created as if a large flat screen were in front in a case where the position P1 is the viewpoint position. This allows the user to view the content in the virtual space in which such a flat screen is set in front.

The image illustrated in B of FIG. 4 is a projection image that includes only the planar image. In a case where the planar image is projected such that the entire planar image fits in the projection surface 11A having a circular shape in front view, a black area that does not display anything is formed around the planar image. With the black area formed, the projection image results in an image that lacks a sense of realism or immersion.

The image processing apparatus 21 causes an effect image to be projected together with a planar image obtained by reproducing content, such that an image representing a predetermined space is displayed around the planar image. The effect image includes an image for producing a virtual space.

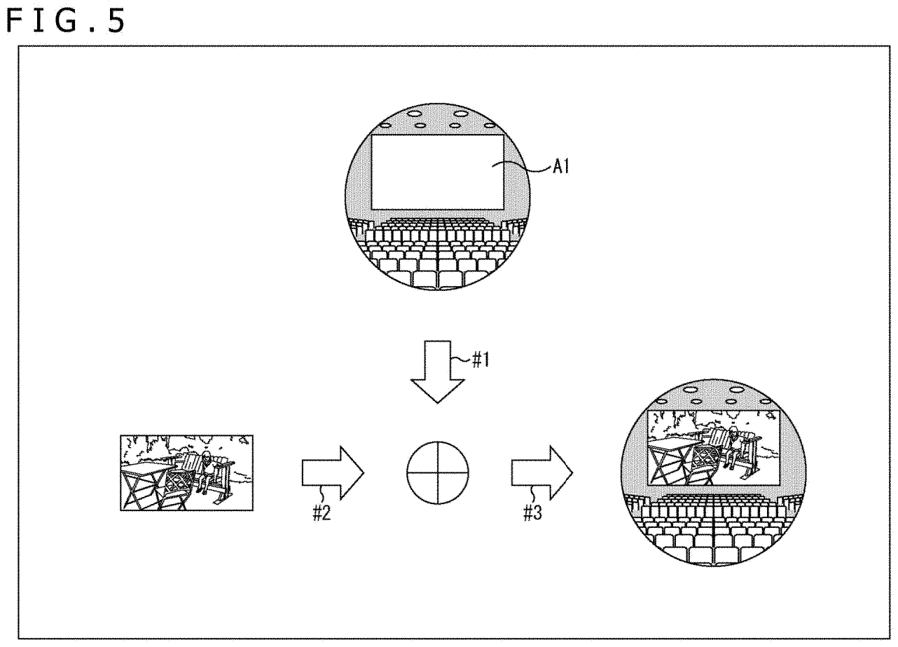

FIG. 5 is a diagram illustrating an example of superimposition of the effect image.

As indicated by white arrows #1 and #2, the effect image having a circular shape is superimposed and arranged as the background of the planar image that is obtained by reproducing the content. A superimposition image indicated by a white arrow #3 and obtained by superimposing the effect image is used for projection.

The effect image illustrated in the upper center of FIG. 5 is an image representing a space in a movie theater. For example, an image used as the effect image includes an image with a wide viewing angle such as a spherical image obtained by photographing a space in a predetermined movie theater.

The effect image may be a moving image or a still image. Further, an image obtained by photographing an indoor space such as a movie theater with a camera may be used as the effect image. Alternatively, a CG image representing a 3D space created by using game creating software or the like may be used as the effect image.

In the effect image illustrated in the upper center of FIG. 5, a superimposition area A1 is formed at a position corresponding to a screen above the line of seats. The superimposition area A1 is an area on which the planar image is superimposed. The superimposition image having a circular shape illustrated on the right side of FIG. 5 is an image generated by arranging the planar image illustrated on the left side of FIG. 5 in the superimposition area A1 of the effect image.

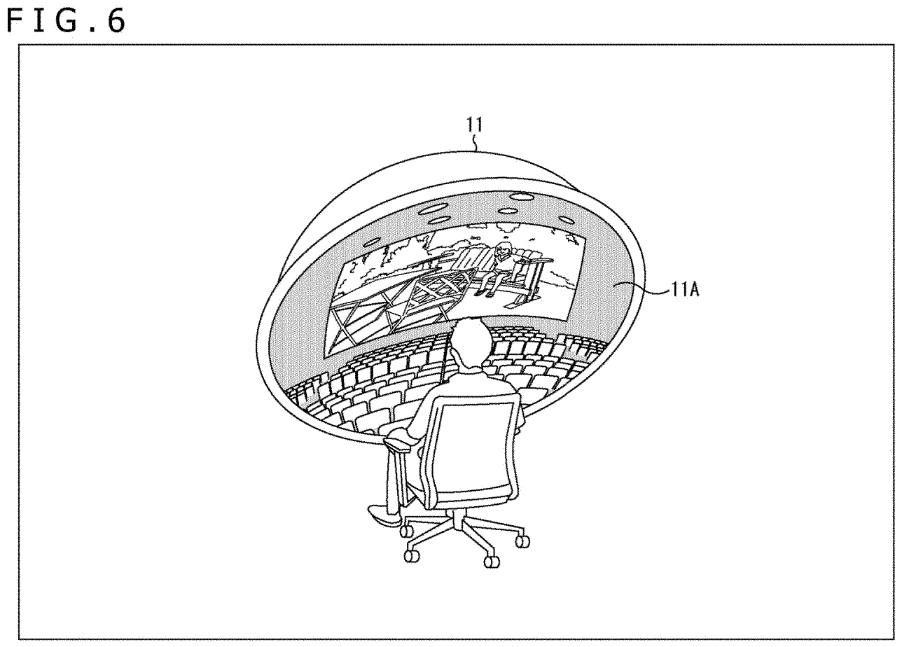

FIG. 6 is a diagram illustrating a projection state.

The superimposition image described with reference to FIG. 5 is projected using the projectors 13L and 13R. Accordingly, as illustrated in FIG. 6, the planar image obtained by reproducing the content is displayed while the effect image is arranged around the planar image.

In such a manner, in the multi-projection system 1, content including a planar image is reproduced and an effect image is projected together with the planar image obtained by reproducing the content. For example, a planar image that is obtained by reproducing content of a movie is displayed while an effect image representing the inside of a movie theater is arranged around the planar image. This arrangement can give the user a sense of realism and immersion as if the user watched the movie in the movie theater.

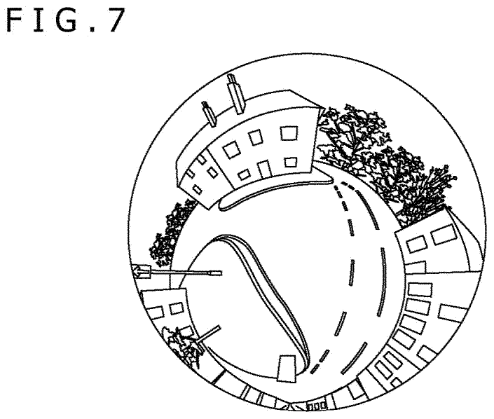

Further, in the multi-projection system 1, not only a superimposition image in which a planar image is superimposed on an effect image, but also a 360-degree image (a partial area of the 360-degree image) as illustrated in FIG. 7 is appropriately projected. The 360-degree image is a spherical image in which the area for the planar image is not formed. The 360-degree image is displayed independently and separately from the planar image.

By projecting the superimposition image including the effect image using the spherical image after the 360-degree image illustrated in FIG. 7, content including both the 360-degree image and the planar image can be provided to the user as a series of content without giving any feeling of strangeness.

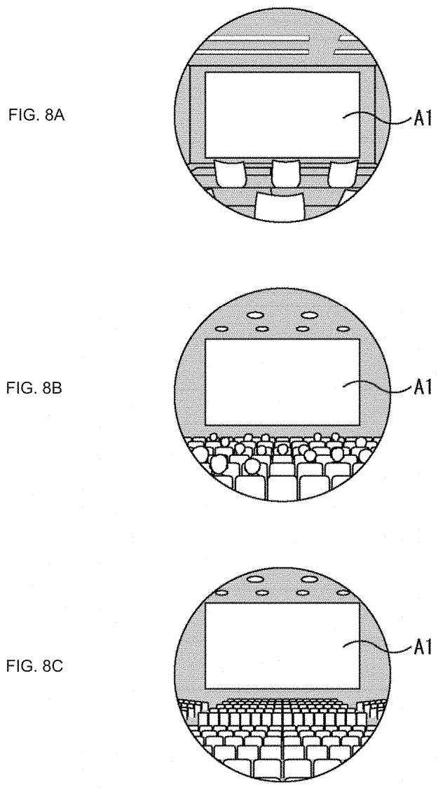

FIG. 8 is a diagram illustrating examples of the effect image.

The effect image illustrated in A of FIG. 8 is an image representing a space in a conference room where tables and seats are lined up. The closer the tables and seats are to the upper side of the image (closer to the center), the smaller they are displayed. The superimposition area A1 is formed at a position above the tables and seats and substantially in the center of the effect image.

The effect image illustrated in B of FIG. 8 is an image representing a space in a movie theater where seats are lined up, and the audience is assumed to be sitting in several seats. The closer the seats are to the upper side of the image or the closer the audience sitting in the seats is to the upper side of the image, the smaller they are displayed. The superimposition area A1 is formed at a position above the seats and slightly above the center of the effect image.

The effect image illustrated in C of FIG. 8 is an image representing a space in a theater where seats are lined up. The closer the seats are to the upper side of the image, the smaller they are displayed. The superimposition area A1 is formed at a position above the seats and on the upper side of the effect image.

In such a manner, the images used as the effect image employ the “perspective technique,” which is a technique that creates a sense of distance to the screen by setting a vanishing point. The effect images illustrated in FIG. 8 are images in which the vanishing point is set substantially in the center so as to create a sense of distance to the screen from the sizes and the like of the objects such as the seats.

Displaying such an image using the “perspective technique” as the effect image can provide the content to the user while appropriately changing how the user feels the size of the planar image arranged in the superimposition area A1.

Specifically, the sense of distance to the virtual screen is adjusted by changing the position and size of the superimposition area A1 or by adjusting how much to make the sizes of the objects, such as the seats arranged in the space, smaller from the front to the back.

In a case where the effect image illustrated in A of FIG. 8 and the effect image illustrated in C of FIG. 8 are compared to each other, the size of the superimposition area A1 is the same therebetween. Even in such a case, the effect image illustrated in C of FIG. 8 can make the user feel as if the user looked at a larger screen. This is based on a visual effect that can make the user feel that the screen arranged in the space in C of FIG. 8 is relatively larger.

As illustrated in B of FIG. 8, the heads of the audience on the lower side are made larger while the heads of the audience on the upper side are gradually made smaller. This representation can make the user feel a sense of distance to the screen more. Moreover, this representation can make the user feel as if the audience other than the user is sitting in the seats.

The sense of distance to the screen is adjusted by changing not only the sizes of the objects arranged on the front of the effect image but also the sizes of the objects arranged above the superimposition area A1.

In the effect image illustrated in A of FIG. 8 and the effect image illustrated in B of FIG. 8, light fixtures embedded in the ceiling are displayed above the superimposition area A1 as objects. The sense of distance to the screen is also adjusted by reducing the sizes of the objects as they are close to the lower side (as they are close to the screen).

Forming the planar image superimposition area at the position of the screen in the movie theater, the conference room, or the like can give the user an effect called a “picture frame effect” or a “frame effect,” which is well known in the world of paintings or the like. The “picture frame effect” or the “frame effect” is such an effect that a frame such as a picture frame arranged around an image can make the target image stand out more or fill a blurred space (e.g., a cloudy sky or the like) and give a shaper impression.

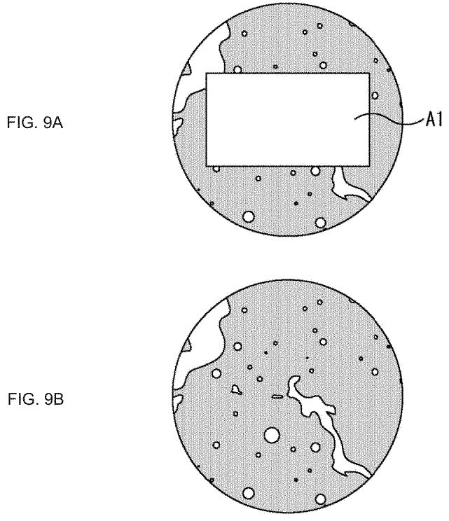

FIG. 9 is a diagram illustrating other examples of the effect image.

The effect image illustrated in A of FIG. 9 is an image representing the outer space including stars as objects. The superimposition area A1 is formed at a position substantially in the center of the effect image.

In such a manner, an image representing a space such as a landscape on the ground that is not provided with a screen in reality may be used as the effect image.

The effect image illustrated in B of FIG. 9 is also an image representing the outer space. In the effect image illustrated in B of FIG. 9, the planar image superimposition area is not formed. In a case where the planar image superimposition area is not formed in the effect image, the image processing apparatus 21 generates a superimposition image by superimposing a planar image at a predetermined position of the effect image.

In such a manner, an image in which no planar image superimposition area is formed may be used as the effect image.

At a predetermined timing such as before the reproduction of content, the user may be allowed to select an effect image to be used for the superimposition of a planar image. In this case, the image processing apparatus 21 uses the effect image selected from a plurality of effect images for the superimposition of the planar image and causes the effect image to be projected on the projection surface 11A.

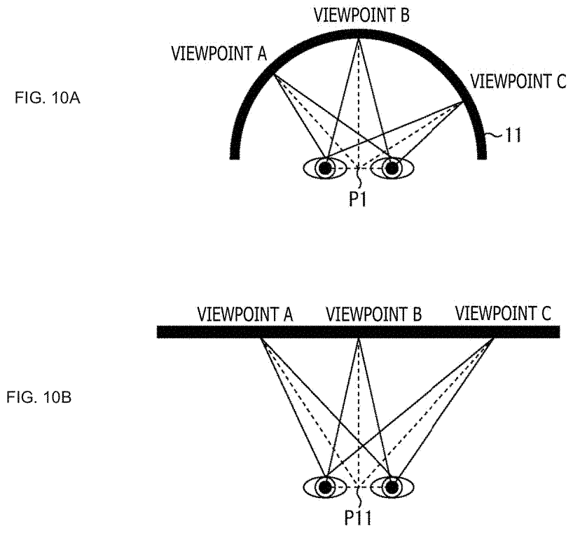

FIG. 10 is a diagram illustrating an effect obtained by projecting the effect image.

As illustrated in A of FIG. 10, the effect image is projected on the dome screen 11. In this case, the distances from the position P1, which is the viewpoint position, to the respective positions on the projection surface 11A are substantially the same, regardless of the distance to the position in the vicinity of the center or the distances to the positions in the vicinity of both ends.

On the other hand, as illustrated in B of FIG. 10, in a case where the effect image is projected on a flat surface as a projection surface, the distances from a position P11, which is the viewpoint position, to the positions in the vicinity of both ends on the projection surface are larger than the distance to the position in the vicinity of the center.

Therefore, the dome screen 11 can more suppress a change in eye focusing under the vision system. Considering the effect images of FIG. 8, eye focusing little changes, regardless of whether or not the user looks at the audience seats in front or the wall or ceiling in the vicinity of the edge. Accordingly, the user can look at any effect image under a condition that is close to a condition when the user looks at objects in an actual space.

In such a manner, in the multi-projection system 1, when a planar image obtained by reproducing content is displayed, an effect image, which can produce a sense of distance to the dome screen 11 and the like and is prepared separately from the planar image, is displayed around the planar image.

A series of operations of the multi-projection system 1, which provides content as described above, will be described later with reference to a flowchart.

### <Configuration of Image Processing Apparatus>

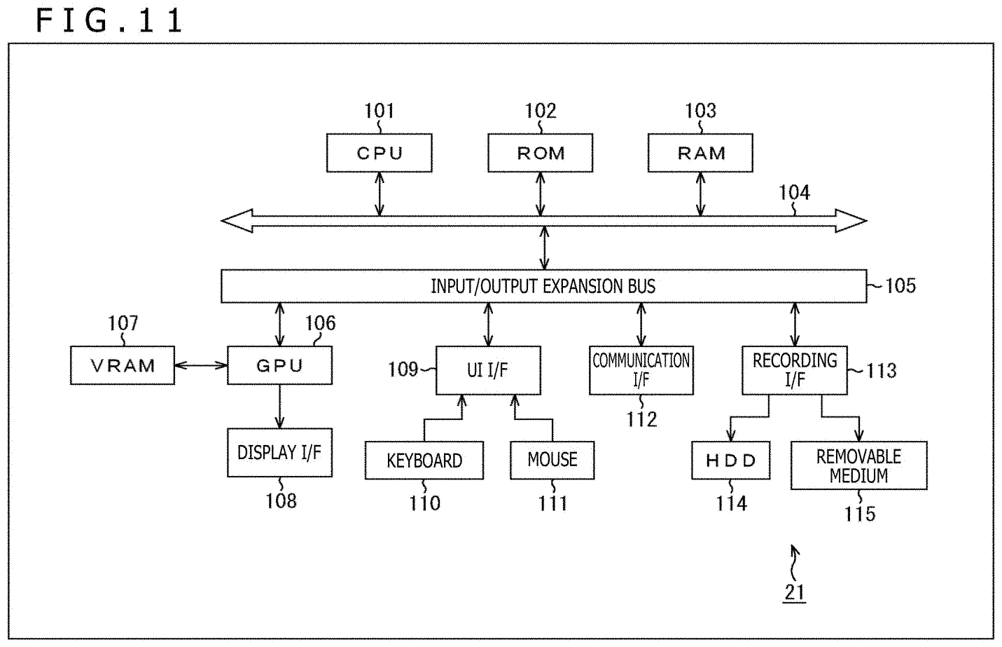

FIG. 11 is a block diagram illustrating an example of a hardware configuration of the image processing apparatus 21.

A CPU (Central Processing Unit) 101, a ROM (Read Only Memory) 102, and a RAM (Random Access Memory) 103 are connected to each other by a bus 104.

An input/output expansion bus 105 is also connected to the bus 104. A GPU (Graphics Processing Unit) 106, a UI (User Interface) I/F 109, a communication I/F 112, and a recording I/F 113 are connected to the input/output expansion bus 105.

The GPU 106 uses a VRAM 107 to render projection images to be projected from the projectors 13L and 13R. For example, the GPU 106 generates projection images to be projected from the respective projectors 13L and 13R on the basis of a superimposition image obtained by superimposing a planar image on an effect image. The projection images generated by the GPU 106 are supplied to a display I/F 108.

The display I/F 108 is an interface for outputting the projection images. The display I/F 108 is, for example, configured as a predetermined standard interface such as HDMI (registered trademark) (High-Definition Multimedia Interface). The display I/F 108 outputs the projection images supplied from the GPU 106 to the projector 13L and the projector 13R, causing the projector 13L and the projector 13R to project the respective projection images.

The UI I/F 109 is an interface for detecting an operation. The UI I/F 109 detects an operation performed using a keyboard 110 or a mouse 111 and outputs information indicating the content of the operation to the CPU 101. The operation using the keyboard 110 or the mouse 111 is performed by, for example, an administrator or user of the multi-projection system 1.

The communication I/F 112 is an interface for communicating with an external apparatus. The communication I/F 112 includes network interfaces such as a wireless LAN and a wired LAN. The communication I/F 112 communicates with an external apparatus through a network such as the Internet to transmit and receive various types of data. The content to be reproduced in the multi-projection system 1 may be provided from a server through the network.

The communication I/F 112 appropriately transmits audio data of content to the surround speaker 14 and the woofer 15 and receives image data photographed by the cameras 16L and 16R and transmitted from the cameras 16L and 16R. In a case where a sensor or the like for detecting the movement of the user is provided in the chair, the communication I/F 112 also receives sensor data transmitted from the sensor.

The recording I/F 113 is an interface for recording media. The recording media such as an HDD 114 and a removable medium 115 are attached to the recording I/F 113. The recording I/F 113 reads data recorded onto the attached recording media and writes data to the recording media. In addition to content and an effect image, various types of data such as a program to be executed by the CPU 101 are recorded onto the HDD 114.

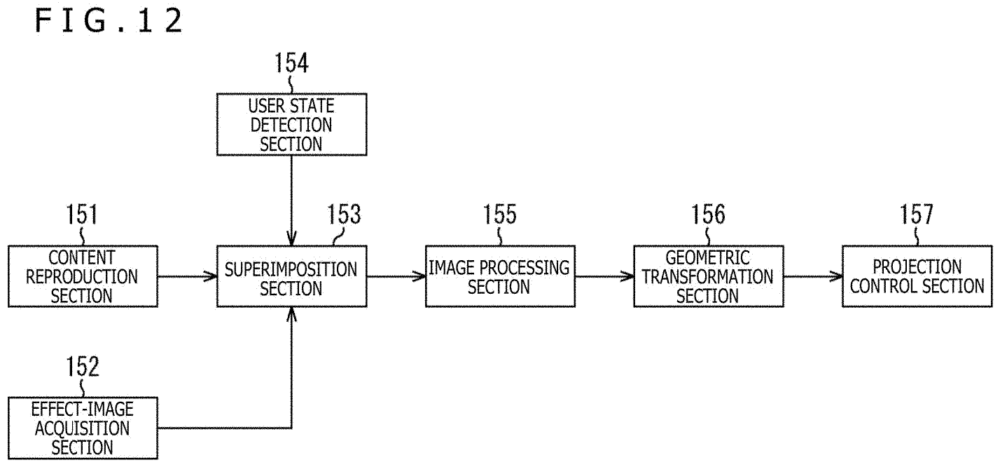

FIG. 12 is a block diagram illustrating an example of a functional configuration of the image processing apparatus 21.

As illustrated in FIG. 12, a content reproduction section 151, an effect-image acquisition section 152, a superimposition section 153, a user state detection section 154, an image processing section 155, a geometric transformation section 156, and a projection control section 157 are implemented in the image processing apparatus 21. At least one of the functional sections illustrated in FIG. 12 is implemented by the CPU 101 of FIG. 11 executing a predetermined program.

The content reproduction section 151 reproduces content such as a movie and outputs a planar image obtained by reproducing the content to the superimposition section 153. The content reproduction section 151 is supplied with content transmitted from the server and received by the communication I/F 112 or content read by the recording I/F 113 from the HDD 114.

The effect-image acquisition section 152 acquires a predetermined effect image from a plurality of effect images prepared in advance in a case where the effect image is a still image, and outputs the effect image to the superimposition section 153. The effect-image acquisition section 152 is supplied with the effect image transmitted from the server and received by the communication I/F 112 or the effect image read by the recording I/F 113 from the HDD 114, thereby acquiring the effect image.

Alternatively, the effect-image acquisition section 152 reproduces moving image data for an effect image in a case where the effect image is a moving image, and outputs each frame to the superimposition section 153 as the effect image.

The superimposition section 153 superimposes the planar image supplied from the content reproduction section 151 on the effect image supplied from the effect-image acquisition section 152. The superimposition section 153 outputs, to the image processing section 155, a superimposition image in which the planar image is arranged at the predetermined position of the effect image.

The superimposition section 153 appropriately switches a range of the effect image used for superimposition according to the state of the user detected by the user state detection section 154. For example, the superimposition section 153 switches a range displayed as the effect image while keeping the planar image in a fixed position.

The user state detection section 154 detects the state of the user viewing the content, such as the direction of the user's line of sight, the direction of the face, the amount of weight shift, and the amount of momentum. The user state detection section 154 detects the state of the user by, for example, using the sensor data measured by the sensor provided in the chair in which the user is sitting or by analyzing images photographed by the cameras 16L and 16R. The user state detection section 154 outputs information indicating the state of the user to the superimposition section 153.

The image processing section 155 performs various types of image processing such as super-resolution processing and color conversion on the superimposition image supplied from the superimposition section 153. The image processing section 155 also appropriately performs image processing such as signal level adjustment taking into account that the projection surface 11A is a curved surface. The image processing section 155 outputs the superimposition image on which the image processing has been performed to the geometric transformation section 156.

The geometric transformation section 156 performs a geometric transformation of the superimposition image supplied from the image processing section 155.

For example, geometric information is prepared in advance for the geometric transformation section 156 as information used for the geometric transformation. In the geometric information, each pixel of the superimposition image including the planar image is associated with each position on the projection surface 11A. The geometric information is generated by, for example, projecting an image of a predetermined pattern from the projectors 13L and 13R, photographing the pattern projected on the projection surface 11A with the cameras 16L and 16R, and associating each position on the image with each position on the projection surface 11A.

The geometric transformation section 156 generates a projection image for the projector 13L and a projection image for the projector 13R on the basis of the superimposition image subjected to the geometric transformation, and outputs the projection images to the projection control section 157.

The projection control section 157 outputs the projection image for the projector 13L to the projector 13L and outputs the projection image for the projector 13R to the projector 13R by controlling the display I/F 108. The projection control section 157 functions as a display control section that controls the display of the content such that the effect image is displayed around the planar image.

### <Operation of Image Processing Apparatus>

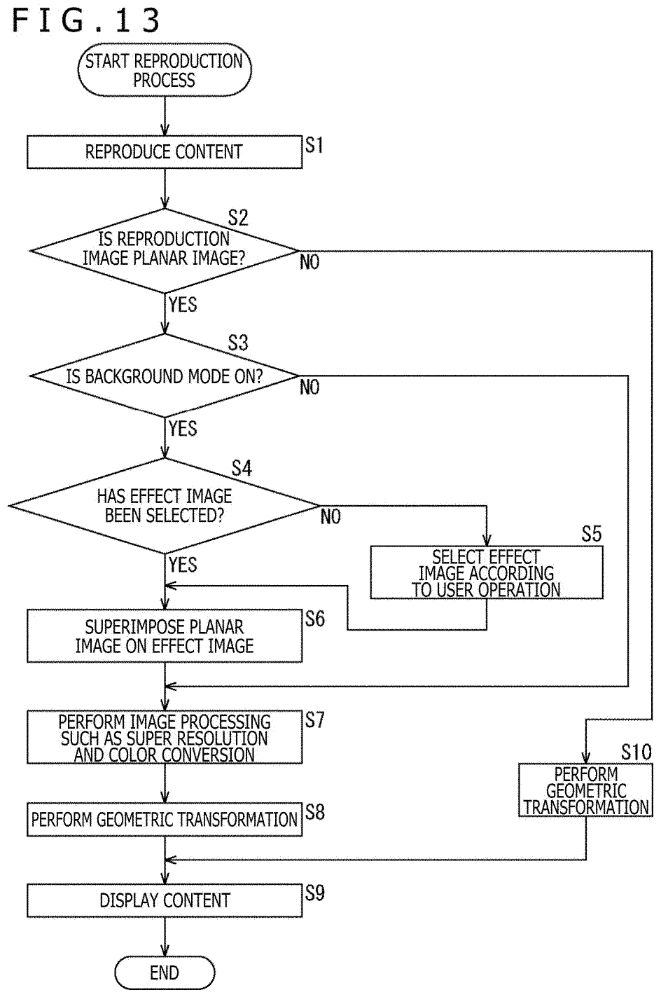

Here, a content reproduction process of the image processing apparatus 21 configured as above will be described with reference to a flowchart of FIG. 13.

The process of FIG. 13 is initiated when instructed to reproduce content by the user sitting in the chair arranged in front of the dome screen 11, for example.

In step S1, the content reproduction section 151 reproduces content such as a movie. The content reproduction section 151 supplies an image obtained by reproducing the content to the superimposition section 153.

In step S2, the superimposition section 153 determines whether or not the image obtained by reproducing the content is a planar image.

In a case where it is determined in step S2 that the image obtained by reproducing the content is a planar image, the superimposition section 153 determines in step S3 whether or not a background mode is ON.

The background mode is a mode that is selected to cause a planar image to be displayed while an effect image is displayed around (as a background for) the planar image. The ON/OFF of the background mode can be selected using a predetermined screen projected on the dome screen 11, for example.

In a case where it is determined in step S3 that the background mode is ON, the effect-image acquisition section 152 determines in step S4 whether or not any effect image has been selected.

In a case where it is determined in step S4 that no effect image has been selected, the effect-image acquisition section 152 selects an effect image according to the user operation in step S5. For example, an effect image selection screen may be displayed on the dome screen 11 to allow the effect image to be selected using the selection screen.

In a case where it is determined in step S5 that the effect image has been selected, or in a case where it is determined in step S4 that the effect image has already been selected, the superimposition section 153 superimposes the planar image on the effect image acquired by the effect-image acquisition section 152 in step S6.

In step S7, the image processing section 155 performs the image processing such as super-resolution processing and color conversion on a superimposition image generated by superimposing the planar image on the effect image. Similarly, in a case where it is determined in step S3 that the background mode is OFF, the image processing section 155 performs, in step S7, the image processing on the planar image around which a black area is formed, for example.

Further, the image processing section 155 also adjusts the signal level of the superimposition image by changing the signal level with the passing of time, for example.

### EXAMPLE 1 OF SIGNAL LEVEL ADJUSTMENT

In a case where the image processing section 155 causes the effect image to be displayed before the planar image, the image processing section 155 causes the effect image to be displayed with a contrast value or a brightness value set to high until initiating the display of the planar image. Further, in a case where it is time to initiate the display of the planar image, the image processing section 155 adjusts the signal level so as to gradually reduce the contrast value or the brightness value of the effect image.

Accordingly, the effect image is displayed in a highlighted state until the display of the planar image is initiated. This naturally makes the user conscious of the virtual space such as a movie theater represented by the effect image. By making the user conscious of the virtual space, it is possible to make the user feel as if the planar image displayed later were large.

Here, in a case where the effect image continues to be displayed in the highlighted state for a long time, the surrounding effect image stands out, disturbing the planar image that is supposed to be the main image. Thus, the signal level of the effect image is gradually reduced over, for example, five minutes according to the dark adaptation characteristics of the human eyes so that the effect image can be prevented from disturbing the planar image.

### EXAMPLE 2 OF SIGNAL LEVEL ADJUSTMENT

Further, the image processing section 155 adjusts the signal level of the superimposition image so as to give a sense of depth. The image processing section 155 adjusts the signal level by varying the signal level according to the position on the superimposition image.

For example, in a case where the image processing section 155 causes the image illustrated in FIG. 5, which represents the space in the movie theater where the seats are lined up, to be displayed as the effect image, the image processing section 155 adjusts the signal level of the image such as the contrast value so as to gradually reduce the signal level from the front (the lower side of the image) to the back (the upper side of the image) of the image. Accordingly, the user can feel as if there were more audience seats in the back.

Conceivably, multiplying an input signal by a linear gain value (a slope value of a linear function) to reduce an output signal is one possible process as a process of reducing the contrast value. Further, in a case where brightness (a value corresponding to an intercept value of a linear function), a gamma value (a correction value for obtaining an output signal having a non-linear logarithmic value with respect to an input signal), and the like are given in advance by tuning, it is conceivable to reduce the output signal using those parameters.

Returning to the description of FIG. 13, in step S8, the geometric transformation section 156 performs a geometric transformation of the superimposition image on which the image processing has been performed, and also generates a projection image for the projector 13L and a projection image for the projector 13R.

In step S9, the projection control section 157 outputs the projection images to the projector 13L and the projector 13R, causing the projector 13L and the projector 13R to project the respective projection images to provide the user with the content with the effect image being displayed around the planar image.

By contrast, in step S2, in a case where the image obtained by reproducing the content is not a planar image but an image such as a 360-degree image generated on the assumption that the image is to be projected on a curved projection surface, the processing proceeds to step S10.

In step S10, the geometric transformation section 156 performs a geometric transformation of the 360-degree image obtained by reproducing the content. After that, in step S9, projection images generated on the basis of the 360-degree image subjected to the geometric transformation are projected from the respective projectors 13L and 13R.

The image projection described above continues until the reproduction of the content ends, for example.

Through the process above, even in a case where the image processing apparatus 21 reproduces content including an image generated on the assumption that the image is to be displayed on a flat surface, the image processing apparatus 21 can effectively utilize the entire projection surface 11A of the dome screen 11 and realize image representation that easily obtains a sense of realism and immersion.

Moreover, utilizing content including an image generated on the assumption that the image is to be displayed on a flat surface can increase the number of pieces of content that can be reproduced in the multi-projection system 1 including the dome screen 11.

### <Regarding Generation of Content>

Although an effect image to be used for the superimposition of a planar image has been assumed to be selected on the reproducing side (the multi-projection system 1 side), the effect image may be selected on the content providing side (the content producing side).

In this case, for example, a content generation apparatus, which is an apparatus on the content providing side, superimposes a planar image on an effect image and generates content including image data in which the planar image and the effect image are superimposed on each other in advance.

Further, information specifying the effect image to be used for the superimposition of the planar image is generated, and content including the information specifying the effect image is generated together with the image data of each of the planar image and the effect image.

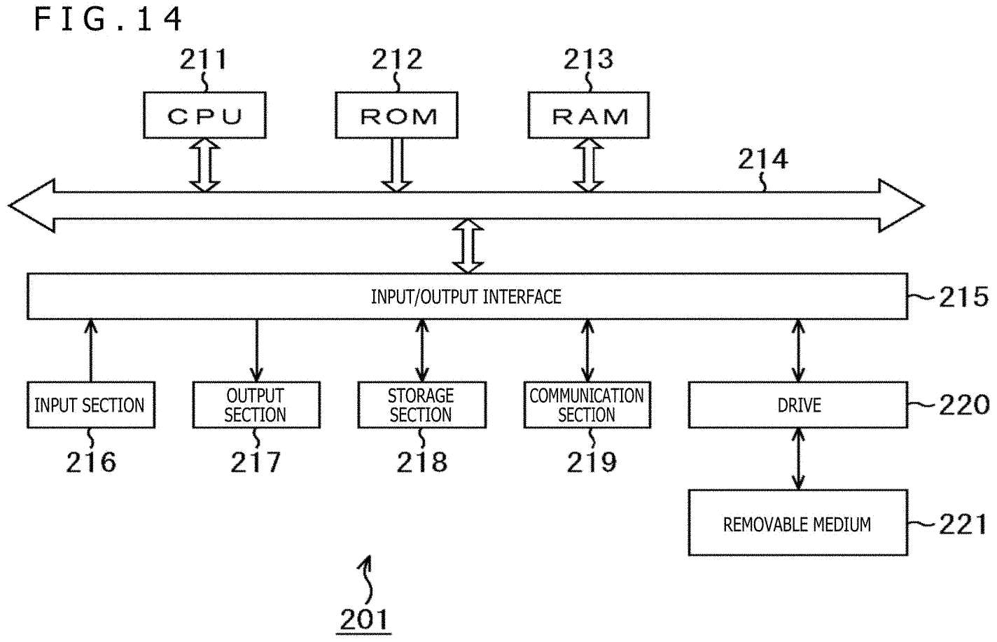

FIG. 14 is a block diagram illustrating an example of a hardware configuration of a content generation apparatus 201.

A CPU 211, a ROM 212, and a RAM 213 are connected to each other by a bus 214.

An input/output interface 215 is also connected to the bus 214. An input section 216, an output section 217, a storage section 218, a communication section 219, and a drive 220 are connected to the input/output interface 215.

The input section 216 includes a keyboard, a mouse, and the like. The input section 216 is operated by a content producer when an effect image is selected, for example.

The output section 217 causes a monitor to display a production screen used for content production.

The storage section 218 includes a hard disk, a non-volatile memory, and the like. The storage section 218 stores various types of data such as a program to be executed by the CPU 211, in addition to data of various types of materials used for content production.

The communication section 219 includes a network interface and the like. The communication section 219 communicates with an external apparatus through a network such as the Internet.

The drive 220 is a drive for a removable medium 221 such as a USB memory with a built-in semiconductor memory. The drive 220 writes data to the removable medium 221 and reads data stored in the removable medium 221.

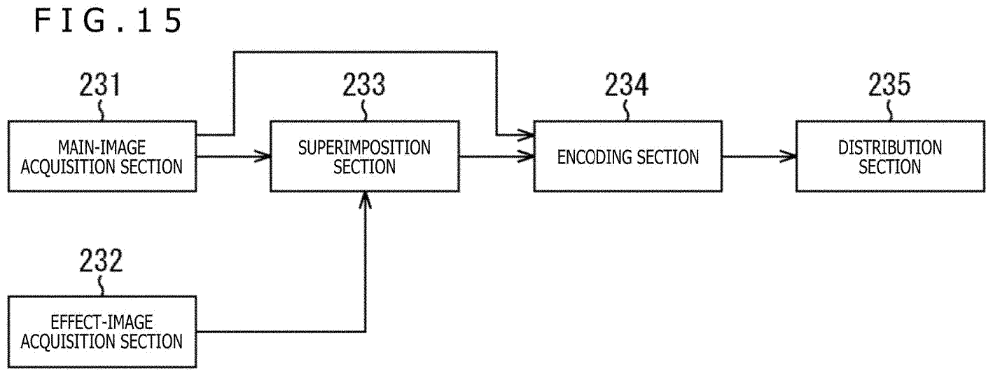

FIG. 15 is a block diagram illustrating an example of a functional configuration of the content generation apparatus 201.

As illustrated in FIG. 15, a main-image acquisition section 231, an effect-image acquisition section 232, a superimposition section 233, an encoding section 234, and a distribution section 235 are implemented in the content generation apparatus 201. At least one of the functional sections illustrated in FIG. 15 is implemented by the CPU 211 of FIG. 14 executing a predetermined program.

The main-image acquisition section 231 acquires a planar image to be superimposed on an effect image by reproducing content generated on the assumption that the content is to be displayed on a flat surface, and outputs the planar image to the superimposition section 233 as a main image of the content.

Further, the main-image acquisition section 231 acquires a 360-degree image generated on the assumption that the 360-degree image is to be displayed on a curved surface, and outputs the 360-degree image to the encoding section 234.

The effect-image acquisition section 232 acquires a predetermined effect image from a plurality of effect images prepared in advance in a case where the effect image is a still image, and outputs the effect image to the superimposition section 233. Alternatively, the effect-image acquisition section 232 reproduces moving image data for an effect image in a case where the effect image is a moving image, and outputs each frame to the superimposition section 233 as the effect image.

The superimposition section 233 superimposes the planar image supplied from the main-image acquisition section 231 on the effect image supplied from the effect-image acquisition section 232. The superimposition section 233 outputs, to the encoding section 234, a superimposition image in which the planar image is arranged at a predetermined position of the effect image. That is, the configuration of the content generation apparatus 201 illustrated in FIG. 15 is a configuration for generating content including image data in which a planar image and an effect image are superimposed on each other in advance.

The encoding section 234 generates a video stream of the content by encoding the superimposition image supplied from the superimposition section 233 or the 360-degree image supplied from the main-image acquisition section 231. The encoding section 234 generates content by, for example, encoding the video stream and audio stream, and outputs the content to the distribution section 235.

The distribution section 235 controls the communication section 219 to communicate with the image processing apparatus 21 of the multi-projection system 1 and transmit the content to the image processing apparatus 21. In this case, the content generation apparatus 201 functions as a server that provides the content through the network. The content may be provided to the image processing apparatus 21 through the removable medium 221.

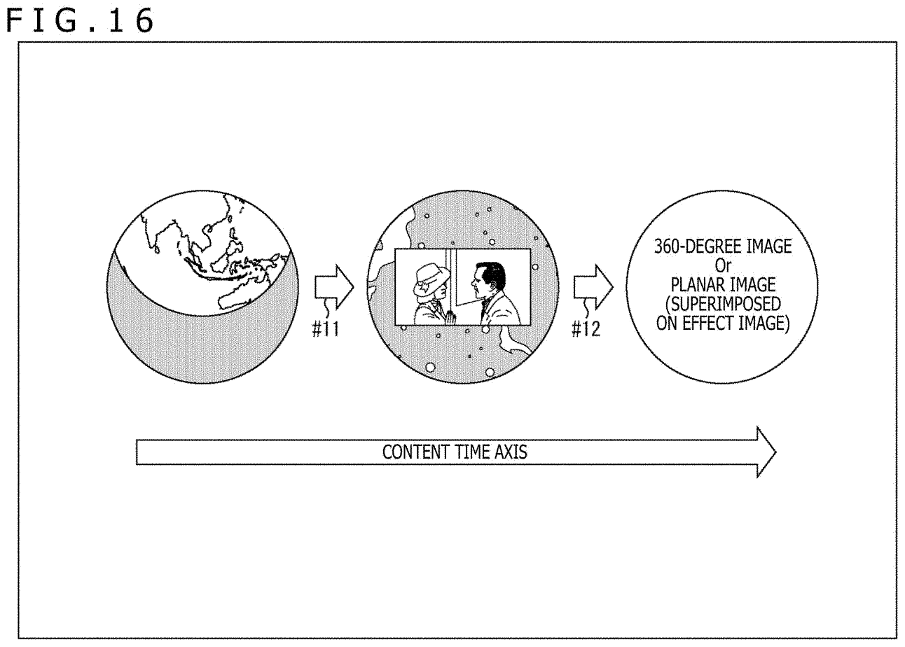

FIG. 16 is a diagram illustrating an example of content including both a planar image and a 360-degree image.

In the example of FIG. 16, the 360-degree image is displayed as an opening image of the content. After that, as indicated by a white arrow #11, the planar image around which an effect image is arranged is displayed. The 360-degree image displayed as the opening image of the content and the effect image displayed around the planar image are, for example, moving images.

After the planar image illustrated in the center of FIG. 16 is displayed, the 360-degree image or the planar image around which the effect image is arranged is displayed as indicated by a white arrow #12.

In such a manner, the content generation apparatus 201 appropriately generates content including both a planar image and a 360-degree image. The image processing apparatus 21 of the multi-projection system 1 reproduces the content generated by the content generation apparatus 201 and causes each image to be projected on the dome screen 11 in the order illustrated in FIG. 16.

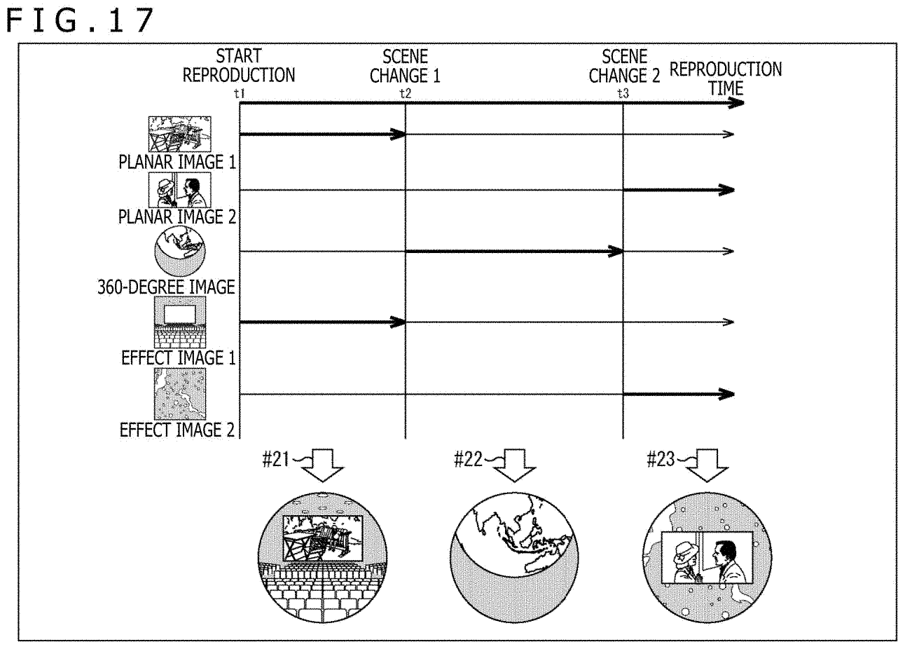

FIG. 17 is a diagram illustrating an example of a timeline of content.

A horizontal axis of FIG. 17 represents the timeline (reproduction time). As illustrated on the left end of FIG. 17, a planar image 1, a planar image 2, a 360-degree image, an effect image 1, and an effect image 2 are prepared in the content generation apparatus 201. The effect image 1 is an image where the superimposition area A1 is formed, while the effect image 2 is an image where the superimposition area A1 is not formed.

The content producer proceeds with content production, for example, by selecting an image to be displayed at each timing using a UI displayed on the monitor of the content generation apparatus 201.

In the example of FIG. 17, the planar image 1 and the effect image 1 are selected as the images to be displayed during a period from time t1, which is immediately after the start of the content reproduction, to time t2 when a scene change 1 takes place. During the reproduction of the content, the planar image 1 around which the effect image 1 is arranged is displayed as indicated by a white arrow #21 in the period from the time t1 to the time t2.

Further, the 360-degree image is selected as the image to be displayed in a period from the time t2 when the scene change 1 takes place to time t3 when a scene change 2 takes place. During the reproduction of the content, the 360-degree image is displayed as indicated by a white arrow #22 in the period from the time t2 to the time t3.

The planar image 2 and the effect image 2 are selected as the images to be displayed in a period after the time t3 when the scene change 2 takes place. During the reproduction of the content, the planar image 2 around which the effect image 2 is arranged is displayed as indicated by a white arrow #23 in the period after time t3.

In a case where various types of images as materials are prepared in the content generation apparatus 201, the content producer can produce content by selecting an image to be displayed at each timing on the timeline. The content also includes control information that specifies the image and the like to be displayed at each timing using a predetermined language such as HTML (Hyper Text Markup Language) or XML (Extensible Markup Language).

### <Modifications>

### EXAMPLE IN WHICH THREE VIRTUAL SCREENS ARE PROVIDED

A description has been given of the case where an effect image includes one superimposition area A1 formed therein and a virtual space realized by projecting the image includes one virtual screen. Alternatively, an image of content may be displayed on a plurality of virtual screens.

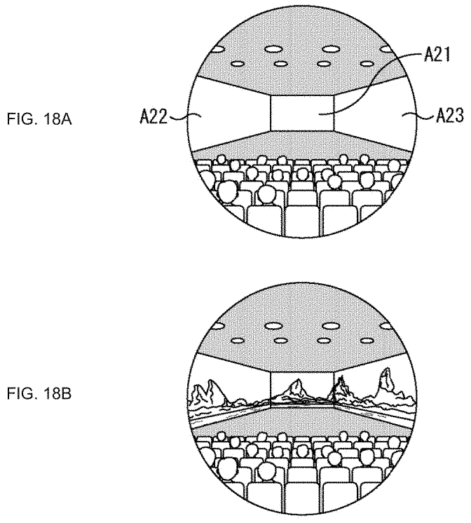

FIG. 18 is a diagram illustrating an example of arrangement of the virtual screens.

The effect image illustrated in A of FIG. 18 is an image representing a space in a movie theater. In the effect image, a superimposition area A21 is formed at a position above the line of seats and substantially in the center of the effect image. A superimposition area A22 and a superimposition area A23 are, respectively, formed on the left and right of the superimposition area A21. To express a sense of depth, the superimposition area A22 and the superimposition area A23 have a shape that extends further in the vertical and horizontal directions toward the corresponding end of the projection surface 11A.

The image processing apparatus 21 superimposes a planar image obtained by reproducing content on each of the superimposition areas A21 to A23 and causes a resulting superimposition image to be projected as illustrated in B of FIG. 18. In the example of B of FIG. 18, a horizontally long image is displayed over the entire superimposition areas A21 to A23.

Accordingly, a space is virtually created as if there were three screens in front. The user can obtain a sense of realism and immersion in the content by viewing the content in the virtual space in which these three screens are set in front.

### EXAMPLE OF CONTROL OF EFFECT IMAGE

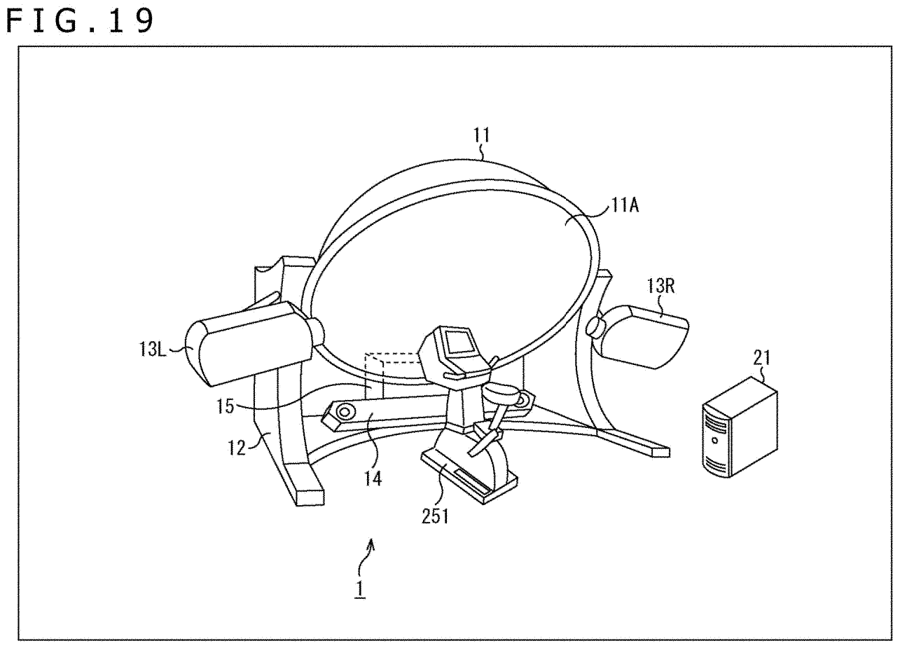

FIG. 19 is a diagram illustrating another example of the configuration of the multi-projection system 1.

In the example of FIG. 19, a fitness bike 251 used for training or the like is arranged fixedly to a floor surface instead of the chair of FIG. 1. The user views content projected on the projection surface 11A while straddling a saddle of the fitness bike 251.

In this case, the image processing apparatus 21 reproduces content of a game, for example. A game screen is displayed as a planar image, while an effect image is displayed around the game screen on the dome screen 11.

A sensor is provided in the fitness bike 251. The fitness bike 251 transmits various types of sensor data to the image processing apparatus 21. Examples of the sensor data include information indicating the amount of pedaling of the user and information indicating the position of the center of gravity when the user leans the body.

The image processing apparatus 21 performs control such that a display content of the effect image is switched according to the sensor data without changing the position of the game screen which is the planar image.

For example, the image processing apparatus 21 generates an effect image in real time in a CG environment and switches a display range of the effect image according to the number of rotations when the user pedals the fitness bike 251. The image processing apparatus 21 may switch the display of the effect image by changing the scroll speed of the image or the frame rate of the display according to the amount of pedaling of the fitness bike 251.

Changing the frame rate of the display can make the user feel as if the user were cycling at a given speed in the virtual space. Moreover, the user can be made to feel a sense of immersion by controlling the display of the virtual space represented not by an effect image as a spherical image but by the CG effect image according to the rotations of the pedals.

The display of the effect image may be controlled on the basis of the sensor data detected by the sensor provided in the chair.

For example, in a case where the user rotates the chair to the right while an effect image using a spherical image is displayed, the image processing apparatus 21 cuts out, from the spherical image, a horizontally left (or a horizontally right) range of the current display range and causes the range to be displayed on the basis of the sensor data detected by the sensor provided in the chair.

The display of the effect image is devised in such a manner on the basis of the sensor data detected by the sensor provided in the equipment such as the chair or the fitness bike 251 used by the user. This allows the user to experience a new interaction.

Various types of equipment such as a car seat and a running machine may be used as the equipment used by the user viewing content.

### OTHER EXAMPLES

An effect image may be downloadable through the network. In this case, a plurality of effect images representing, for example, spaces in famous movie theaters and theaters around the world is prepared in the server that provides effect images.

In a case where the user selects a predetermined movie theater or theater by specifying a country name or a region name or specifying a movie theater name or a theater name, the effect image representing a space in the selected movie theater or theater is downloaded and used for superimposition of a planar image in the image processing apparatus 21.

Accordingly, the user can feel as if the user were viewing content in famous spaces around the world.

Although the small dome-shaped screen is used as the display device, it is also possible to use a curved display configured by bonding together a plurality of panels in which LED elements are arranged, a self-luminescent display device such as an organic EL display whose display surface is deformed into a curved shape, or the like.

Although the projection surface 11A of the dome screen 11 has a substantially hemispherical dome shape, any of curved surfaces with a variety of curvatures and angles of view can be employed as the shape of the projection surface 11A.

Head tracking may be performed by detecting, for example, the line of sight of the viewer, and the projection range may be controlled according to the line of sight.

The functional sections of the image processing apparatus 21 may be implemented by a plurality of PCs; some of the functional sections of the image processing apparatus 21 may be implemented by a predetermined PC, while the other functional sections may be implemented by other PCs.

The functional sections of the image processing apparatus 21 may be implemented by a server on the Internet, and an image may be projected on the basis of data transmitted from the server.

The series of processes described above can be performed by hardware or software. In a case where the series of processes is to be performed by software, a program included in the software is installed from a program recording medium into the computer of FIG. 11 or the like included in the image processing apparatus 21.

The program to be executed by the CPU 101 is, for example, recorded onto the removable medium 115 or provided through a wired or wireless transmission medium such as a local area network, the Internet, or digital broadcasting, and then installed into the HDD 114.

The program to be executed by the computer may be a program that performs processes in a time-series manner in the order described in the present specification or a program that performs processes in parallel or at necessary timings on occasions of calls or the like.

It is noted that in the present specification, a system refers to a collection of a plurality of constituent elements (apparatuses, modules (components), and the like), and it does not matter whether or not all the constituent elements are within the same housing. Therefore, a plurality of apparatuses stored in separate housings and connected through the network, and one apparatus storing a plurality of modules in one housing are, in either case, the system.

The effects described in the present specification are merely examples and are not limited. Further, there may be additional effects.

The embodiment of the present technology is not limited to the above-described embodiment, and various modifications can be made without departing from the scope of the present technology.

For example, the present technology can be configured as cloud computing in which one function is shared and processed collaboratively among a plurality of apparatuses through the network.

Further, each step described in the above-described flowchart can be performed by one apparatus or can be shared and performed by a plurality of apparatuses.

Moreover, in a case where one step includes a plurality of processes, the plurality of processes included in this one step can be performed not only by one apparatus but also by a plurality of apparatuses in a shared manner.

The present technology can also have the following configurations.

(1)

An image processing apparatus including:

a display control section configured to cause a planar image and an effect image to be displayed on a curved display surface such that an image representing a predetermined space is displayed as the effect image around the planar image, the planar image having been generated on an assumption that the planar image is to be displayed on a flat surface.

(2)

The image processing apparatus according to (1), in which the display control section causes a projector to project the planar image and the effect image on a screen having a curved projection surface as the display surface.

(3)

The image processing apparatus according to (2), in which the screen includes a dome-shaped screen.

(4)

The image processing apparatus according to (1), in which the display control section causes a curved display to display the planar image and the effect image.

(5)

The image processing apparatus according to any one of (1) to (4), further including:

a superimposition section configured to superimpose the effect image, in which a superimposition area for superimposing the planar image is formed, and the planar image on each other,

in which the display control section causes a superimposition image obtained by superimposing the effect image and the planar image on each other to be displayed.

(6)

The image processing apparatus according to (5), in which the display control section uses, for the superimposition of the planar image, the effect image selected by a user from a plurality of the effect images whose superimposition areas for superimposing the planar image are formed at different positions.

(7)

The image processing apparatus according to any one of (1) to (6), further including:

a detection section configured to detect a state of a user in front of the display surface,

in which the display control section switches a display content of the effect image according to the state of the user without changing a position of the planar image.

(8)

The image processing apparatus according to (7), in which the detection section detects the state of the user on the basis of information detected by a sensor provided in equipment used by the user.

(9)

The image processing apparatus according to (7), in which the detection section detects the state of the user by analyzing an image photographed by a camera that includes the user in a photographing range.

(10)

The image processing apparatus according to any one of (1) to (9), in which in a case where the display control section causes the planar image to be displayed after the effect image is displayed, the display control section causes the effect image with a reduced signal level to be displayed after initiating the display of the planar image.

(11)

The image processing apparatus according to any one of (1) to (10), in which the display control section causes the effect image with a varied signal level according to a position of each area on the display surface to be displayed.

(12)

The image processing apparatus according to any one of (1) to (11), in which the effect image includes an image in which a vanishing point is set at a predetermined position.

(13)

An image processing method including:

causing, by an image processing apparatus, a planar image and an effect image to be displayed on a curved display surface such that an image representing a predetermined space is displayed as the effect image around the planar image, the planar image having been generated on an assumption that the planar image is to be displayed on a flat surface.

(14)

A program for causing a computer to perform a process including:

causing a planar image and an effect image to be displayed on a curved display surface such that an image representing a predetermined space is displayed as the effect image around the planar image, the planar image having been generated on an assumption that the planar image is to be displayed on a flat surface.

(15)

A projection system including:

a screen having a curved projection surface;

a projector configured to project an image on the screen; and

an image processing apparatus including a projection control section configured to cause the projector to project a planar image and an effect image on the projection surface such that an image representing a predetermined space is displayed as the effect image around the planar image, the planar image having been generated on an assumption that the planar image is to be displayed on a flat surface.

### REFERENCE SIGNS LIST

1 Multi-projection system, 11 Dome screen, 11A Projection surface, 13L, 13R Projector, 14 Surround speaker, 15 Woofer, 16L, 16R Camera, 21 Image processing apparatus, 151 Content reproduction section, 152 Effect-image acquisition section, 153 Superimposition section, 154 User state detection section, 155 Image processing section, 156 Geometric transformation section, 157 Projection control section, 201 Content generation apparatus, 231 Main-image acquisition section, 232 Effect-image acquisition section, 233 Superimposition section, 234 Encoding section, 235 Distribution section

1. An image processing apparatus comprising:
a display control section configured to cause a planar image and an effect image to be displayed on a curved display surface such that an image representing a predetermined space is displayed as the effect image around the planar image, the planar image having been generated on an assumption that the planar image is to be displayed on a flat surface.

2. The image processing apparatus according to claim 1, wherein the display control section causes a projector to project the planar image and the effect image on a screen having a curved projection surface as the display surface.

3. The image processing apparatus according to claim 2, wherein the screen includes a dome-shaped screen.

4. The image processing apparatus according to claim 1, wherein the display control section causes a curved display to display the planar image and the effect image.

5. The image processing apparatus according to claim 1, further comprising:
a superimposition section configured to superimpose the effect image, in which a superimposition area for superimposing the planar image is formed, and the planar image on each other,
wherein the display control section causes a superimposition image obtained by superimposing the effect image and the planar image on each other to be displayed.

6. The image processing apparatus according to claim 5, wherein the display control section uses, for the superimposition of the planar image, the effect image selected by a user from a plurality of the effect images whose superimposition areas for superimposing the planar image are formed at different positions.

7. The image processing apparatus according to claim 1, further comprising:
a detection section configured to detect a state of a user in front of the display surface,
wherein the display control section switches a display content of the effect image according to the state of the user without changing a position of the planar image.

8. The image processing apparatus according to claim 7, wherein the detection section detects the state of the user on a basis of information detected by a sensor provided in equipment used by the user.

9. The image processing apparatus according to claim 7, wherein the detection section detects the state of the user by analyzing an image photographed by a camera that includes the user in a photographing range.

10. The image processing apparatus according to claim 1, wherein in a case where the display control section causes the planar image to be displayed after the effect image is displayed, the display control section causes the effect image with a reduced signal level to be displayed after initiating the display of the planar image.

11. The image processing apparatus according to claim 1, wherein the display control section causes the effect image with a varied signal level according to a position of each area on the display surface to be displayed.

12. The image processing apparatus according to claim 1, wherein the effect image includes an image in which a vanishing point is set at a predetermined position.

13. An image processing method comprising:
causing, by an image processing apparatus, a planar image and an effect image to be displayed on a curved display surface such that an image representing a predetermined space is displayed as the effect image around the planar image, the planar image having been generated on an assumption that the planar image is to be displayed on a flat surface.

14. A program for causing a computer to perform a process comprising:
causing a planar image and an effect image to be displayed on a curved display surface such that an image representing a predetermined space is displayed as the effect image around the planar image, the planar image having been generated on an assumption that the planar image is to be displayed on a flat surface.

15. A projection system comprising:
a screen having a curved projection surface;
a projector configured to project an image on the screen; and
an image processing apparatus including a projection control section configured to cause the projector to project a planar image and an effect image on the projection surface such that an image representing a predetermined space is displayed as the effect image around the planar image, the planar image having been generated on an assumption that the planar image is to be displayed on a flat surface.
